(19) United States
(12) Patent Application Publication
(10) Pub. No.: US 2023/0152907 A1
(43) Pub. Date: May 18, 2023

(54) GLIDE FOR MOUSE, MANUFACTURING METHOD THEREOF, AND MOUSE HAVING SAME

(71) Applicant: APLUSX Inc., Seongnam-si (KR)

(72) Inventor: Kun Hee SHIM, Seoul (KR)

(73) Assignee: APLUSX Inc., Seongnam-si (KR)

(21) Appl. No.: 17/550,469

(22) Filed: Dec. 14, 2021

(30) Foreign Application Priority Data
Nov. 18, 2021 (KR) 10-2021-0159329
Dec. 7, 2021 (KR) 10-2021-0173553

(51) Int. Cl. G06F 3/0354

(52) U.S. Cl. CPC G06F 3/03543; C03B 27/00

(57) ABSTRACT

The present disclosure relates to a glide for a mouse, which is made of a glass material and is disposed on an area of the bottom surface of the mouse in order to reduce friction between the bottom surface of the mouse and a support and optimize performance of the mouse when the mouse moves, a manufacturing method thereof, and a mouse having the same.

### CROSS-REFERENCE TO RELATED APPLICATION

A claim for priority under 35 U.S.C. § 119 is made to Korean Patent Application Nos. 10-2021-0159329 filed on Nov. 18, 2021 and 10-2021-0173553 filed on Dec. 7, 2021 in the Korean Intellectual Property Office, the entire contents of which are hereby incorporated by reference.

### BACKGROUND

### 1. Technical Field

The present disclosure relates to a glide for a mouse, a manufacturing method thereof, and a mouse having the same.

### 2. Description of Related Art

A mouse is one input device of a computer, and a user holds the mouse with the hand to use. When the user moves the mouse, a cursor on a display screen of the computer. When the user clicks a button of the mouse, commands are executed.

However, while the mouse moves, the bottom surface of the mouse may be worn away due to friction generated between the bottom surface of the mouse and a support, for instance, a mouse pad or a desk, and so, performance of the mouse may be deteriorated.

### PATENT LITERATURE

### Patent Documents

Patent Document 1: US Patent Publication No. 2020/0039384 A1 (Feb. 6, 2020)

### SUMMARY

The present disclosure has been made to solve the above-mentioned problems occurring in the prior art, and it is an object to provide a glide for a mouse, which is made of a glass material and is disposed on an area of the bottom surface of the mouse in order to reduce friction between the bottom surface of the mouse and a support and to optimize performance of the mouse when the mouse moves, a manufacturing method thereof, and a mouse having the same.

The objects of the present disclosure are not limited to those mentioned above, and other objects not mentioned herein will be clearly understood by those skilled in the art from the following description.

To accomplish the above objects, there is provided a manufacturing method of a glide for a mouse, the method including: preparing unit glass by cutting mother glass into a specific shape; forming an edge preparation portion chamfered or rounded with a predetermined radius of curvature along the circumference of the unit glass; polishing the edge preparation portion of the unit glass; quenching the polished unit glass; and coating the unit glass with anti-fingerprint agents.

Moreover, preparing the unit glass is performed by laser machining, and forming the edge preparation portion is performed by CNC machining.

Furthermore, the mother glass is made of an aluminosilicate glass material.

Additionally, after polishing, the method further includes cleaning the polished unit glass with ultrasonic waves.

In addition, after quenching, the method further includes forming a printed portion by printing at least one among specific shapes, patterns or texts printed on the tempered glass portion; and drying the printed portion printed on the unit glass.

Moreover, in forming the printed portion, the printed portion is formed by glass ink printing.

In another aspect of the present disclosure, there is provided a glide for a mouse including: a tempered glass portion cut into a specific shape; an edge preparation portion chamfered or rounded with a predetermined radius of curvature along the circumference of the tempered glass portion; a printed portion having any one among specific shapes, patterns or texts printed on the tempered glass portion; and an anti-fingerprint coated portion coated on the tempered glass portion with anti-fingerprint coating agents.

In another aspect of the present disclosure, there is provided a mouse including: a graspable mouse body; and a glide mounted on an area of the bottom surface of the mouse body, the glide including a tempered glass portion cut into a specific shape, an edge preparation portion having a predetermined radius of curvature along the circumference of the tempered glass portion and being chamfered, a printed portion having any one among specific shapes, patterns or texts printed on the tempered glass portion, and an anti-fingerprint coated portion coated on the tempered glass portion with anti-fingerprint coating agents.

Specific matters of other embodiments are included in the detailed description and drawings of the present disclosure.

The glide for a mouse, the manufacturing method thereof, and the mouse having the same according to an embodiment of the present disclosure can reduce friction between the bottom surface of the mouse and a support, and optimize performance of the mouse when the mouse moves, since the glide for the mouse is made of a glass material and is disposed on an area of the bottom surface of the mouse.

The objects of the present disclosure are not limited to those mentioned above, and other objects not mentioned herein will be clearly understood by those skilled in the art from the following description.

### BRIEF DESCRIPTION OF THE DRAWINGS

FIG. 1 is a flow chart illustrating a manufacturing method of a glide for a mouse according to an embodiment of the present disclosure.

FIG. 2 is a perspective view illustrating a mouse and a glide for a mouse according to an embodiment of the present disclosure.

FIG. 3 is an exploded perspective view illustrating the mouse and the glide for a mouse according to the embodiment of the present disclosure.

### DETAILED DESCRIPTION

Advantages and features of the present disclosure and methods accomplishing the advantages and features will become apparent from the following detailed description of exemplary embodiments with reference to the accompanying drawings. However, the present invention is not limited to exemplary embodiment disclosed herein but will be implemented in various forms. The exemplary embodiments are provided so that the present invention is completely disclosed, and a person of ordinary skilled in the art can fully understand the scope of the present invention. Therefore, the present invention will be defined only by the scope of the appended claims

Unless otherwise defined, all terms (including technical and scientific terms) used herein have the same meaning as commonly understood by those skilled in the technical field to which the present disclosure pertains. It will be further understood that terms, such as those defined in commonly used dictionaries, should not be interpreted in an idealized or overly formal sense unless expressly so defined herein.

Hereinafter, preferred embodiments of the present disclosure will be described in detail with reference to the accompanying drawings.

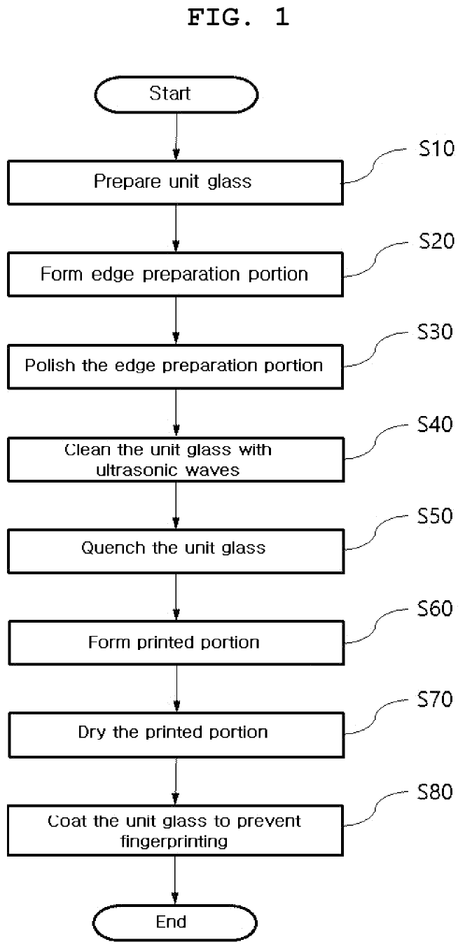

FIG. 1 is a flow chart illustrating a manufacturing method of a glide for a mouse according to an embodiment of the present disclosure.

Referring to FIG. 1, the manufacturing method of a glide for a mouse according to an embodiment of the present disclosure includes the steps of: (S10) preparing unit glass; (S20) forming an edge preparation portion; (S30) polishing the edge preparation portion; (S40) cleaning the unit glass with ultrasonic waves; (S50) quenching the unit glass; (S60) forming a printed portion; (S70) drying the printed portion; and (S80) coating the unit glass to prevent fingerprinting.

First, in the step (S10) of preparing unit glass, mother glass is cut into a specific shape to prepare unit glass. Here, cutting the mother glass means that the mother glass is cut into a shape corresponding to a glide for a mouse, which is a finished product. Furthermore, the glide for the mouse, which is the finished product is not specifically limited in its shape, but may be in a disc shape or in an arc shape.

In an embodiment, the step (S10) of preparing unit glass is performed by laser beam machining. Here, laser beam machining means that the mother glass is cut into a specific shape to prepare unit glass. The prepared unit glass does not transform and contaminate the cut surface, and can improve machining accuracy of the cut surface.

In an embodiment, the mother glass is made of an aluminosilicate glass material. Here, the aluminosilicate glass includes alkali metal oxide, aluminum oxide, and silicon dioxide, and is prevented from breakage by external shock.

Next, in the step (S20) of forming an edge preparation portion, an edge preparation portion which has a predetermined curvature radius and is chamfered along the circumference of the unit glass is formed. Here, the edge preparation portion may be chamfered along the circumference of the tempered glass portion.

In an embodiment, the step (S20) of forming an edge preparation portion is performed by computerized numerical control (CNC) machining. Here, the CNC machining means to form an edge preparation portion by rounding the circumference of the unit glass using a machine tool. Alternatively, the CNC machining may mean to form an edge preparation portion by chamfering along the circumference of the unit glass using a machine tool.

Next, in the step (S30) of polishing the edge preparation portion, the edge preparation portion of the unit glass is polished. In this instance, burrs remaining on the edge preparation portion can be removed. Meanwhile, in the polishing step, not only the edge preparation portion of the unit glass but also the entirety of the unit glass can be polished.

After that, in the step (S40) of cleaning the unit glass with ultrasonic waves, the polished unit glass is cleaned with ultrasonic waves.

Next, in the step (S50) of quenching the unit glass, the polished unit glass is quenched. Here, quenching is performed in such a way that the unit glass is heated at 600° C. to 700° C. and is quickly cooled by a spray of cooling fluid. As described above, the unit glass quenched at 600° C. to 700° C. has the quality of tempered glass. That is, when the unit glass is quenched, the surface of the unit glass is thermally expanded due to intense heat, and it causes compression stress. The inside of the unit glass gets relatively smaller in thermal expansion than the surface of the unit glass. So, in order to adjust balance of power, tensile strength to expand outwards is generated. Therefore, the unit glass is not easily broken by external force due to the increase of intensity, and can reduce generation of scratches on the unit glass due to the increase of surface hardness.

Meanwhile, after quenching of the unit glass, if necessary, a fault inspection in connection with the tempered glass property of the unit glass may be carried out. In this instance, if the tempered glass property of the unit glass is bad, the unit glass may be scrapped.

Next, in the step (S60) of forming a printed portion, at least one among specific patterns, shapes and texts is printed on the quenched unit glass so as to form a printed portion. Here, the printed portion may be formed by glass ink printing. Moreover, glass ink is not specifically limited, but may include glass powder, inorganic color pigments, and oil.

After that, in the step (S70) of drying the printed portion, the printed portion printed on the unit glass is dried. Here, drying the printed portion is not limited specifically, but the printed portion can be dried by being left unattended or by ultraviolet rays irradiated to the printed portion. On the other hand, after the printed portion is dried, if necessary, a fault inspection in connection with shape-matching of the printed portion is carried out. In this instance, if the shape of the printed portion formed on the unit glass is different from a predetermined shape, the unit glass may be scrapped.

Next, in the step (S80) of coating the unit glass to prevent fingerprinting, the unit glass is coated with anti-fingerprint coating agents. Then, manufacturing of a glide for a mouse is finished. In an embodiment, the anti-fingerprint coating agents are not limited specifically, but may be fluorine-based or silicone-based anti-fingerprint coating agents.

After that, double-sided adhesive tape may be adhered on one side of the glide for the mouse or adhesives may be applied to one side of the glide, and then, the glide for the mouse can be mounted on an area of the bottom surface of the mouse.

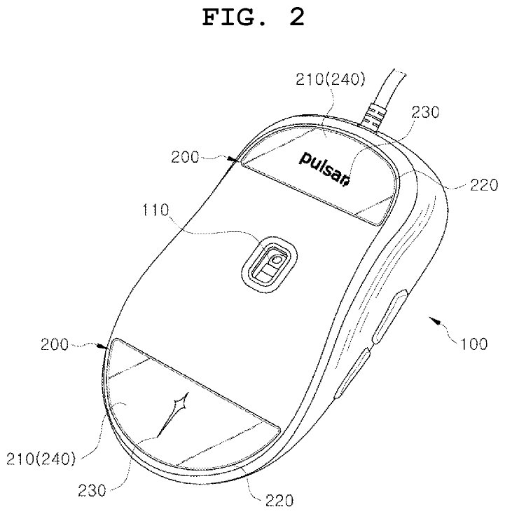

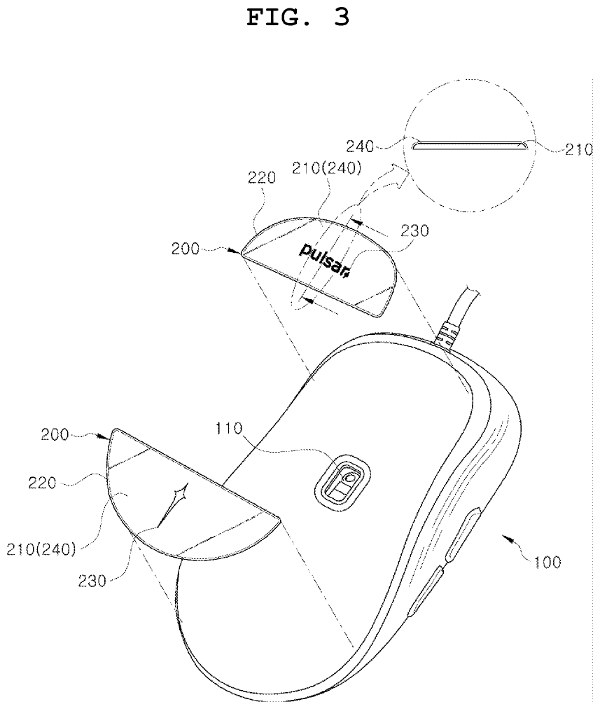

FIG. 2 is a perspective view illustrating a mouse and a glide for a mouse according to an embodiment of the present disclosure, and FIG. 3 is an exploded perspective view illustrating the mouse and the glide for a mouse according to the embodiment of the present disclosure.

As illustrated in FIGS. 2 and 3, the glide 200 for the mouse according to the embodiment of the present disclosure includes a tempered glass portion 210, an edge preparation portion 220, a printed portion 230, and a coated portion 240.

The tempered glass portion 210 is cut into a specific shape. The tempered glass portion 210 may be tempered glass formed in a way that the mother glass is cut into a unit glass of a specific shape and the unit glass is quenched. Here, cutting of the mother glass may be performed by laser machining.

The edge preparation portion 220 has a predetermined radius of curvature along the circumference of the tempered glass portion 210, and rounding is applied to the edge preparation portion to be curved. The edge preparation portion 220 may be chamfered. Here, the rounding or the chamfering of the tempered glass portion 210 may be performed by CNC machining of the unit glass before the unit glass is quenched to be tempered.

The printed portion 230 has any one among specific shapes, patterns and texts printed on the tempered glass portion 210. The printed portion 230 may be formed by glass ink printing. Additionally, the glass ink is not limited specifically, but may be glass powder, inorganic color pigments, and oil.

The anti-fingerprint coated portion 240 is formed in a way that the tempered glass portion 210 is coated with anti-fingerprint coating agents. In an embodiment, the anti-fingerprint coating agents are not limited specifically, but may be fluorine-based or silicone-based anti-fingerprint coating agents.

Referring to FIGS. 2 and 3, the mouse according to the embodiment of the present invention includes a graspable mouse body 100, and a glide 200 mounted on an area of the bottom surface of the mouse body 100.

The glide 200 for the mouse includes the tempered glass portion 210 cut into a specific shape; the edge preparation portion 220 having a predetermined radius of curvature along the circumference of the tempered glass portion 210 and being rounded; the printed portion 230 having any one among specific shapes, patterns or texts printed on the tempered glass portion 210; and the anti-fingerprint coated portion 240 coated with anti-fingerprint coating agents. The glide 200 for the mouse can be manufactured by the above-mentioned manufacturing method. Here, the edge preparation portion 220 may be chamfered.

Meanwhile, in the drawings, a pair of the glides 200 are arranged on the bottom surface of the mouse body 100 to face each other across a sensor unit 110, but are not limited to the above. One or more glide for a mouse may be located at various locations of the bottom surface of the mouse body 100.

The glide for a mouse, the manufacturing method thereof, and the mouse having the same according to the present disclosure can reduce friction between the bottom surface of the mouse and a support, and optimize performance of the mouse when the mouse moves, since the glide 200 for the mouse is made of a glass material and is disposed on an area of the bottom surface of the mouse.

The above description is only exemplary, and it will be understood by those skilled in the art that the invention may be embodied in other concrete forms without changing the technological scope and essential features. Therefore, the above-described embodiments should be considered only as examples in all aspects and not for purposes of limitation.

1. A manufacturing method of a glide for a mouse, the method comprising:
preparing unit glass by cutting mother glass into a specific shape;
forming an edge preparation portion chamfered or rounded with a predetermined radius of curvature along the circumference of the unit glass;
polishing the edge preparation portion of the unit glass;
quenching the polished unit glass; and
coating the unit glass with anti-fingerprint agents.

2. The method of claim 1, wherein preparing the unit glass is performed by laser machining, and
wherein forming the edge preparation portion is performed by CNC machining.

3. The method of claim 1, wherein the mother glass is made of an aluminosilicate glass material.

4. The method of claim 1, further comprising: after polishing,
cleaning the polished unit glass with ultrasonic waves.

5. The method of claim 1, further comprising: after quenching,
forming a printed portion by printing at least one among specific shapes, patterns or texts printed on the tempered glass portion; and
drying the printed portion printed on the unit glass.

6. The method of claim 5, wherein in forming the printed portion, the printed portion is formed by glass ink printing.

7. A glide for a mouse comprising:
a tempered glass portion cut into a specific shape;
an edge preparation portion chamfered or rounded with a predetermined radius of curvature along the circumference of the tempered glass portion;
a printed portion having any one among specific shapes, patterns or texts printed on the tempered glass portion; and
an anti-fingerprint coated portion coated on the tempered glass portion with anti-fingerprint coating agents.

8. A mouse comprising:
a graspable mouse body; and
a glide mounted on an area of the bottom surface of the mouse body, the glide including a tempered glass portion cut into a specific shape, an edge preparation portion chamfered or rounded with a predetermined radius of curvature along the circumference of the tempered glass portion, a printed portion having any one among specific shapes, patterns or texts printed on the tempered glass portion, and an anti-fingerprint coated portion coated on the tempered glass portion with anti-fingerprint coating agents.
